(19) United States
(12) Patent Application Publication
(10) Pub. No.: US 2014/0147801 A1
(43) Pub. Date: May 29, 2014

(54) GRAPHITE CRUCIBLE

(71) Applicant: Masahiro Yasuda, Ogaki-shi (JP)

(72) Inventor: Masahiro Yasuda, Ogaki-shi (JP)

(73) Assignee: IBIDEN CO., LTD., Ogaki-shi, Gifu (JP)

(21) Appl. No.: 14/129,547

(22) PCT Filed: Mar. 28, 2012
(86) PCT No.: PCT/JP2012/058254

§ 371 Date: Dec. 27, 2013

(30) Foreign Application Priority Data
Aug. 5, 2011 (JP) 2011-171793

(51) Int. Cl. F27B 14/10

(52) U.S. Cl. CPC F27B 14/10
USPC 432/265

(57) ABSTRACT

There is provided a graphite crucible including a bottom part, a body part, a treatment part including an input port, and a gas discharge part that is closed at a lower end side and is opened at an upper end side of the body part. Since graphite is porous, at the time when graphite is eluted into an object to be treated or is consumed, a gas in the pores of a graphite crucible is released as air bubbles continuously into the molten object to be treated. Therefore, gasification of a gas dissolved inside the object to be treated can be enhanced, and bumping of the object to be treated can be prevented.

### TECHNICAL FIELD

The present invention relates to a graphite crucible, and more particularly to a graphite crucible for melting an object to be treated, such as a metal.

### BACKGROUND ART

In the metallurgy-related industries, crucibles have been widely used. Object substances (objects to be treated) include, for example, tin (melting point: 232° C.), lead (melting point: 328° C.), aluminum (melting point: 660° C.), copper (melting point: 1083° C.), silicon (melting point: 1410° C.), iron (melting point: 1539° C., nickel (melting point: 1726° C.), and the like. The selection of a crucible would be made depending on thermal resistance of the object to be treated and the reactivity of the object to be treated with the crucible.

In particular, since crucibles for melting an object to be treated such as an iron-based object needs thermal resistance of 1,400° C. or higher and corrosion resistance, there are used crucibles made of oxide-based ceramics such as alumina, and magnesia, or graphite-based crucibles in which graphite is added to the oxide-based ceramics.

As the oxide-based ceramics for use in these crucibles, those having most suitable chemical composition, winch exhibit corrosion resistance against various molten metals or slag, are used. For example, for steel or cast iron melting, alumina, magnesia, zirconia, zircon, spinel, and the like are used as aggregates. Furthermore, in the graphite-based crucibles, it has been described that thermal shock resistance of crucibles is enhanced by adding graphite that has high heat conductivity and low elastic modulus (Patent Document 1).

### BACKGROUND ART DOCUMENTS

### Patent Documents

Patent Document 1: JP-A-H11-116336

### SUMMARY OF THE INVENTION

### Problems to be Solved by the Invention

However, when the above conventional crucibles are used, there has been brown a problem that a gas ma be suddenly generated inside the object to be treated and the object to be treated is scattered outside the crucible, and thus, the scattered metal may contaminate and/or damage a melting apparatus.

An object of the invention is to provide a graphite crucible capable of melting an object to be treated safely without scattering it to form a solidified body.

### Means for Solving the Problems

The invention provides the following:
(1) A graphite crucible comprising: a bottom part; a body part; a treatment part including an input port; and a gas discharge part that is closed at a lower end side and is opened at an upper end side of the body part.
(2) The graphite crucible according to (1), wherein the gas discharge part is formed in a groove shape.
(3) The graphite crucible according to (1) or (2), wherein a thickness of the bottom part is thicker than a minimum value of a distance between a periphery of the gas discharge part and an inner periphery of the crucible.
(4) The graphite crucible according to any one of (1) to (3), wherein the graphite crucible has a bulk density ranging from 1,700 to 1,850 kg/m³.
(5) The graphite crucible according to any one of (1) to (4) wherein the graphite crucible has an impurity content of 1.0 % by mass or less.
(6) The graphite crucible according to (5), wherein the graphite crucible has an impurity content of 0.1% by mass or less.
(7) The graphite crucible according to any one of (1) to (6), wherein the graphite crucible is used for melting an object to be treated selected from an iron-based object, a silicone-based object, a nickel-based object, or a titanium-based object, and a mixture thereof.
(8) A method for producing a solidified body of an object to be treated using the graphite crucible according to any one of (1) to (7).

### Effects of the Invention

Since graphite is porous, at the time when graphite is eluted into an object to be treated or is consumed, a gas in the pores of a graphite crucible is released as air bubbles continuously into the molten object to be treated. Therefore, since it is thought that gasification of a gas dissolved inside the object to be treated can be induced and enhanced, it is thought that bumping from the graphite crucible can be prevented. Moreover, in the case where the object to be treated contains an oxide, it is reduced by graphite to generate a gas of CO Of CO₂ and similarly the gas of CO or CO₂ is continuously released as air bubbles into the molten object to be treated. As a result, similarly, gasification of impurities contained in the object to be treated is enhanced. so that it is thought that sudden boiling of the impurities contained in the object to be treated and bumping from the graphite crucible can be prevented. Since the bumping from the graphite crucible can be prevented, it is thought that scattering, of the object to be treated into the apparatus on which the graphite crucible is provided and contamination thereof can be prevented.

Furthermore, since the graphite crucible has a gas discharge part that is opened at the upper end side of the body part, in the case where a corrosive gas or a reactive gas is generated from the object to be treated or by the reaction of the object to be treated with graphite, the corrosive gas or reactive gas passing through the body part of the graphite crucible can be introduced into the gas discharge part. Therefore, it is possible to make the inside of the melting apparatus difficult to be filled with the corrosive gas or reactive gas. As a result, it is thought that corrosion of the melting apparatus can be prevented even when a porous graphite crucible is used.

### BRIEF DESCRIPTION OF THE DRAWINGS

FIG. 1(A) is a sectional view along the A-A line in FIG. 1(B) including a central axis of a graphite crucible according to an embodiment 1 of the invention, and FIG. 1(B) is a top plan view of the graphite crucible according to the embodiment 1 of the invention.

FIG. 2(A) is a sectional view including a central axis of a graphite crucible according to an embodiment 2 of the invention, and FIG. 2(B) is a top plan view of the graphite crucible according to the embodiment 2 of the invention.

FIG. 3 shows a binary phase diagram of Si—C.

FIG. 4 shows a binary phase diagram of Fe—C.

FIG. 5 shows a polarization-microscopic photograph of a boundary region between the graphite crucible and the object to be treated (iron) at a divided cross-section after heating according to an embodiment of the invention.

### DESCRIPTION OF EMBODIMENTS

In the invention the direction toward a bottom pat of the graphite crucible is defined to be lower, and the opposite side at which the crucible is opened is defined to be upper.

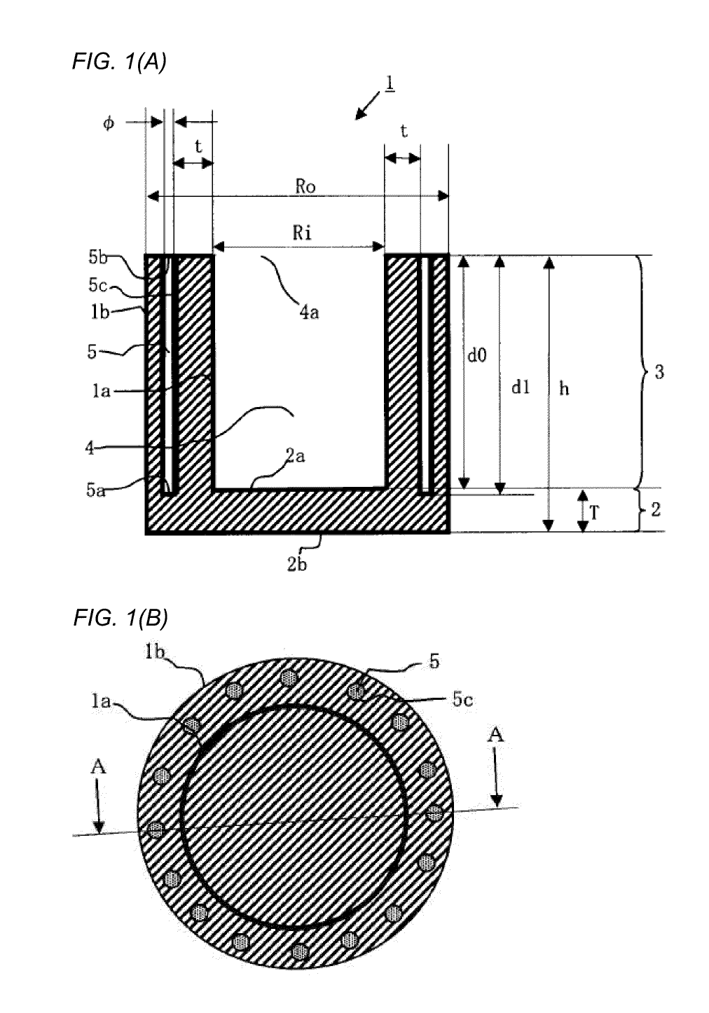

FIG. 1 shows a graphite crucible according to the embodiment 1 of the invention. Specifically, FIG. 1(A) is a sectional view along the A-A line in FIG. 1(B) including a central axis of the graphite crucible according to the embodiment 1 of the invention, and FIG. 1(B) is a top plan view of the graphite crucible according to the embodiment 1 of the invention.

In the embodiment 1 of the invention, the graphite crucible means that graphite is a substantial constitutional component thereof. Iii the invention, graphite may be any kind of graphite and may be anisotropic graphite such as an extruded material or an embossed material or an isotropic graphite material obtained by cold isostatic molding (CIP molding: Cold Isostatic Press). In particular, the graphite obtained by the CIP molding has high strength since a tine raw material (e.g., cokes having a particle diameter of 10 to 20 μm) can be used, and hence, the texture becomes fine. Moreover, since pressurization is performed using a liquid pressurization medium, an isotropic material can be obtained. Since there is no directivity in thermal expansion coefficient, distorted deformation hardly occurs, and thus, thermal stress caused by the distorted deformation is hardly generated, so that it is possible to make troubles such as cracks less likely to occur.

The graphite crucible 1 according to the embodiment 1 of the invention is characterized by including a bottom part 2, a body part 3, and a treatment part 4 haying an inlet port 4a, and further including a gas discharge part 5 that is opened at the upper end side of the body part.

In the graphite crucible 1 according, to the embodiment 1 of the invention, a space excluding the gas discharge part 5 from the space between a crucible inner periphery 1a that defines the space of the treatment part 4 and a crucible outer periphery 1b is made of graphite.

The bottom part 2 is a part below an inner bottom surface 2a when the crucible is cut out to the crucible outer periphery by the plane including the inner bottom surface 2a that is a lower end part of the crucible inner periphery 1a. The inner bottom surface 2a may be a curved surface instead of a planar surface as shown in FIG. 1(A). As the curved surface, there may be a curved surface having an extreme point at the lower end of the crucible inner periphery, where the tangent surface of the extreme point coincides with the inner bottom surface 2a. The bottom part 2 has an outer bottom surface 2b that corresponds to the lower end surface of the crucible outer periphery 1b.

The body part 3 is a part between the crucible inner periphery 1a and the crucible outer periphery 1b and is a part other than the bottom part 2 of the graphite crucible 1.

So long as the gas discharge part 5 is a space (hole) closed at the lower end side and opened at the upper end side of the body part and has a function of discharging a gas, the shape, size, position of the closed port, the number, and the like thereof are not particularly limited. The gas discharge part 5 shown in FIG. 1(A) and FIG. 1(B) is cylindrical and has a closed port 5a at the lower end side and an opened port 5b at the upper end side of the body part, 20 pieces of the gas discharge part 5 are concentrically provided in the body part, and they are provided at such positions that the central angles thereof are mutually separated by almost 18°. The position of the closed port 5a is slightly lower than the inner bottom surface 2a.

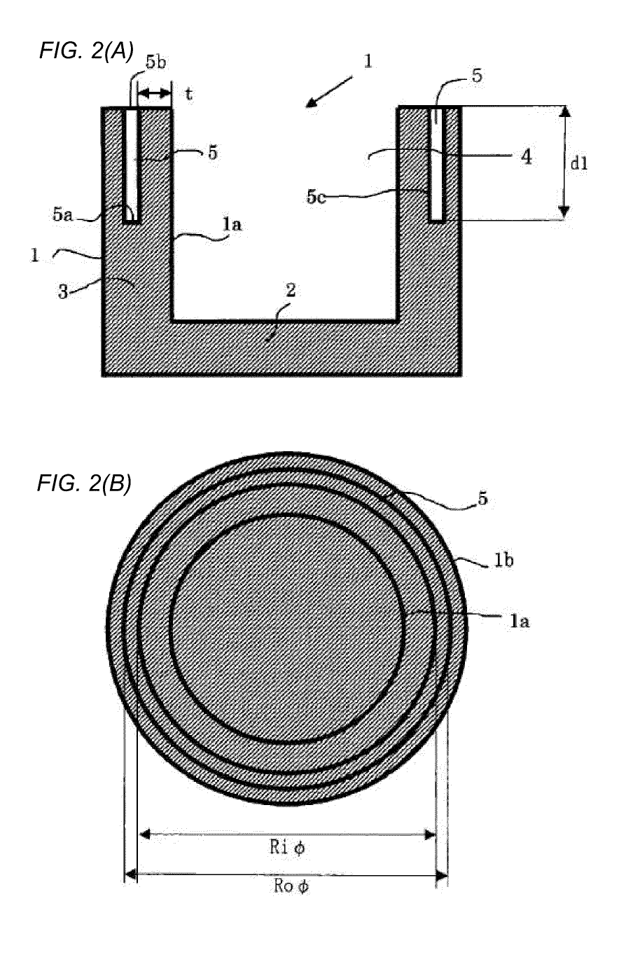

The thickness T of the bottom part 2 is preferably thicker than the minimum value of the distance t between the gas discharge part periphery 5c and the crucible inner periphery 1a. As for the distance t between the gas discharge part periphery 5c and the crucible inner periphery 1a, since is of each hole falls within a certain range for each of 20 pieces of the gas discharge part, the smallest one among them is taken as the minimum value. The minimum value is the smallest one of the distances t between the respective gas discharge part peripheries 5c and the crucible inner periphery 1a. The thickness of the bottom part 2 is a distance between the inner bottom surface 2a and the outer bottom surface 2b. In the case where the inner bottom surface 2a is a curved surface, the thickness is a distance between the above-described tangent surface and the outer bottom surface 2b. Incidentally, the relationship between the thickness of the bottom part 2 and the distance t is the same in the case where the gas discharge part shown in the embodiment of FIG. 2 is employed.

Since the graphite constituting the graphite crucible 1 is porous, it has many pores inside. Since it has pores, air bubbles are generated in the course of elution of the graphite into the object to be treated at the time of melting and are diffused into the molten object to be treated. On this occasion, gasification of the impurities contained in the object to be treated is enhanced and the bumping of the object to be treated can be prevented.

Furthermore, in the case where the object to be treated contains an oxide, it is reduced by the graphite to generate a gas of CO or CO₂, and similarly the gas of CO or CO₂ is continuously released as an bubbles into the molten object to be treated. As a result, gasification of the impurities contained in the object to be treated is enhanced, so that it is thought that sudden boiling of the impurities contained in the object to be treated and the bumping can be prevented. Since the bumping can be prevented, it is thought that scattering of the object to be treated into the apparatus and contamination thereof can be prevented.

The gas discharge part 5 functions as a discharge port of a gas as described above. Since the graphite crucible is made of graphite that is porous, it has a property that a gas easily permeates even to the outside of the graphite crucible. Depending on the component(s) contained in the object to be treated, a gas is generated from the object to be treated itself or by the reaction with the graphite crucible.

In the case of the object to be treated containing chlorine such as polyvinyl chloride, a chlorine-based gas is generated. For example, in the case where the object to be treated contains fluorine such as poly a fluorine-based gas is generated. In the case where the object to be treated contains a sulfate salt or a sulfite salt, it reacts with graphite to generate a corrosive gas such as hydrogen sulfide,

Since the graphite crucible 1 has the gas discharge part 5, a gas generated by the reaction with the crucible can be discharged to the upper part of the crucible through the gas discharge part 5 of die body part 3. The gas discharged as such can be rapidly discharged from the melting apparatus by appropriately providing a discharge port of the melting apparatus on the graphite crucible. By providing such a gas discharge part 5, it is thought that the corrosive gas that may be generated from the object to be treated itself or by the reaction with the graphite crucible can be effectively prevented from filling the inside of die melting apparatus to corrode the inside of the melting apparatus.

As described above, the thickness T of the body part 2 is preferably thicker than the minimum value of the distance t between the gas discharge part periphery 5c and the crucible inner periphery 1a. The reason will be described below.

When a solid (clumpy or powdery) object to be treated is placed in the graphite crucible 1 and melted, the object to be treated is reduced in volume in the process thereof and is likely to gather on the bottom of the graphite crucible. In many cases, in order to efficiently use the graphite crucible, the object to be treated is added repeatedly until the object to be treated is sufficiently filled in the treatment part 4 of the graphite crucible. Therefore, the bottom part 2 of the graphite crucible is in contact with the object to be treated for a longer period of time. Particularly, in the case of melting an iron-based object to be treated, the graphite constituting the graphite crucible becomes easily eluted into the object to be treated. Therefore, as described above, by thickening the thickness T of the bottom part that is in contact with the object to be treated for a long period of time, the graphite crucible can be prevented from having a hole or from damaging.

The graphite crucible 1 of the invention preferably has a bulk density ranging from 1,700 to 1,850 kg/m³. When the bulk density is 1,850 kg an or less, an bubbles can be continuously fed to melt at the time of the elution of graphite since a sufficient amount of pores are present. When the bulk density is 1,700 kg/m³ or more, the specific surface area of graphite can be decreased, so that the rate of elution can be diminished and the graphite crucible can be made less likely to have a hole.

The graphite crucible 1 of the invention preferable has an impurity content of 1.0% by mass or less. When the impurity content is 1.0% by mass or less, an impurity layer owing to remaining impurities can be made less likely to be formed on the crucible inner periphery even if the graphite is corroded. Furthermore, the graphite crucible 1 preferably has an impurity content of 0.1% by mass or less. When the impurity content is 0.1% by mass or less, an impurity layer owing to remaining impurities can be made further less likely to be formed on the crucible inner periphery even if the graphite is corroded. Since the impurities are less likely to accumulate on the crucible inner periphery, the elution of the graphite continuously occurs, and simultaneously with the elution, the gas contained in the pores is released as air bubbles into the molten object to be treated. As a result, it is thought that the components contained in the inside of the molten object to be treated become hardly overheated and bumping can be made less likely to occur. Therefore, it is thought that contamination and damage of the inside of the apparatus caused by bumping can be prevented.

Incidentally, the above action of the graphite crucible 1 is not limited to the case under atmospheric pressure and it similarly functions even under reduced pressure. Even when the mass of the gas present in the pores of graphite is small under the reduced pressure, the gas can expand and form air bubbles owing to low pressure.

The impurity content of the graphite crucible 1 is preferably as low as possible, for example, 0% by mass.

The graphite crucible 1 is preferably a graphite crucible used tar melting an iron-based, a silicon-based, is nickel-based, or it titanium-based object to be treated or an object to be treated composed of a mixture thereof. Since these elements form carbides, air bubbles can be generated with consuming the graphite crucible at the time of melting these elements. Therefore, the bumping of the object to be treated can be made less likely to occur.

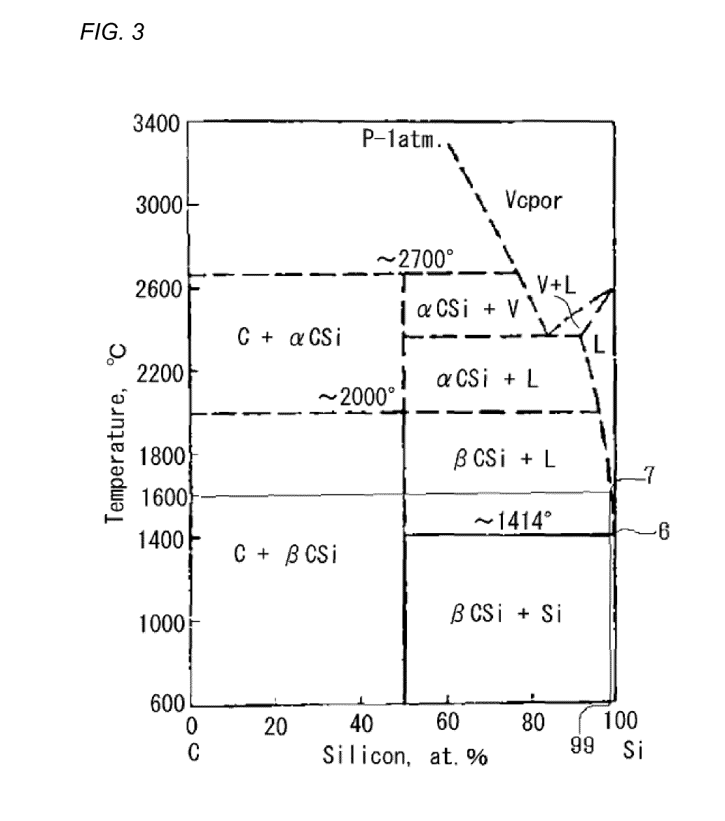

The mechanism of elution of the graphite constituting the graphite crucible 1 into the silicon contained in the object to be treated will be described with reference to the Si—C binary phase diagram of FIG. 3 (Micro Structure of Silicon Carbide Grinding Tools; M. Moser, Periodica Polytechnica CH21/1 1976.6.30). In FIG. 3, the abscissa at the lower part represents an element ratio of silicon and the ordinate represents temperature. When silicon is placed in a graphite crucible and heated, the silicon is melted at 1,414° C. as shown by 6 in the Si—C binary phase diagram of FIG. 3. When the temperature is further elevated to 1,600° C., the silicon melt becomes to contain carbon in an amount of about 1% as shown by 7. The carbon concentration of the melt increases with melting the graphite on the surface of the graphite crucible. Since the silicon is melted with melting the graphite and au bubbles are generated from the pores of the graphite, the bumping of the object to be treated can be made less likely to occur.

Incidentally, at the time of melting silicon in the graphite crucible, die surface layer of the graphite crucible forms SiC. Since even SiC is eluted into the melt, air bubbles can be generated.

With regard to the graphite crucible 1, in the case of melting an iron-based object to be treated, since temperature is high and also graphite is easily eluted into the object to be treated, the graphite crucible 1 is easily consumed and air bubbles are easily generated, so that bumping can be effectively prevented.

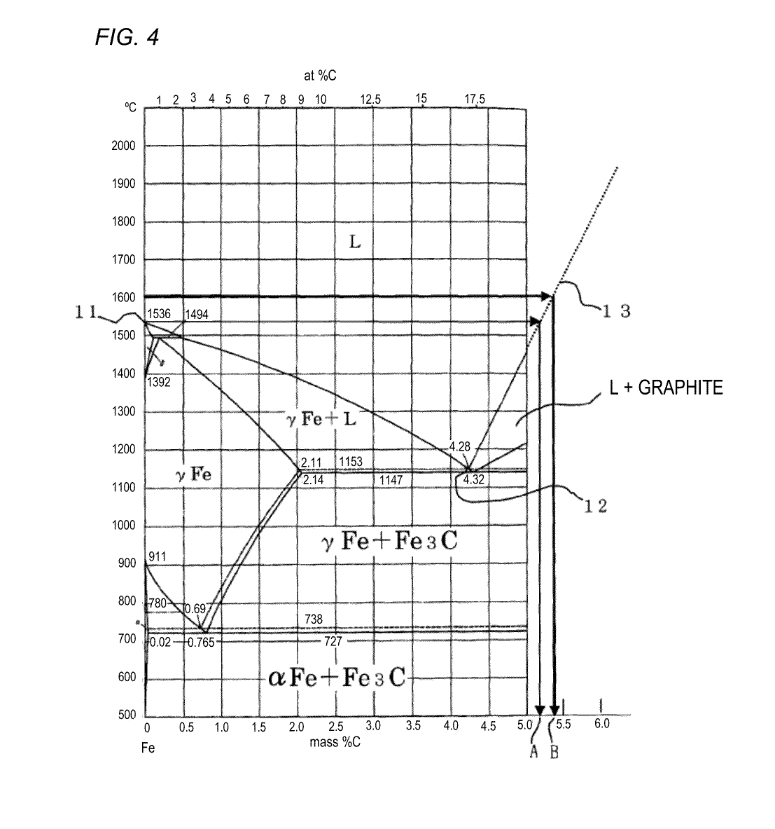

The mechanism of eluting the graphite constituting the graphite crucible 1 into the iron contained in the object to be treated will be described with reference to the Fe—C binary phase diagram of FIG. 4. In FIG. 4 (Metal data Book, revised 4th edition, Japan Institute of Metals 2004 Feb. 29), the abscissa at the lower part represents a mass ratio of carbon (% by mass), the abscissa at the upper part represents an element ratio of carbon (atom %), and the ordinate represents temperature. When the iron is heated as shown by the sign 11 in the Fe—C binary phase diagram of FIG. 4, it is melted at 1,536° C. Since the molten iron dissolves carbon, when the temperature of 1,536° C. is still maintained, the elution of carbon ceases at the time when 5.2% by mass (A) of carbon is contained in the melt. During the process, air bubbles are continuously released from the pores of the graphite and hence the bumping of the object to be treated can be made less likely to occur. Incidentally, when the temperature is maintained at 1,536° C., it is adequate for the graphite crucible to have such a sufficient thickness that a graphite material corresponding to 5.2% by mass of the molten material may be eroded from the graphite crucible. When the temperature is further elevated, the saturated concentration of carbon increases. For example, in the case of 1,600° C., the elution of carbon ceases at the time when at most about 5.5% (B) of carbon is contained, which is % by mass of carbon at which the liquidus line 13 from the eutectic point 12 intersects the line of 1,600° C. Therefore, since a lamer amount of graphite is eroded when hot treatment temperature is elevated, much more air bubbles can be generated. As a result. bumping can be made less likely to occur even in the use at a high temperature at which bumping easily occurs. Incidentally, erosion should be supposed in an amount of about 5.5% based on the iron contained in the object to be treated in the case of the use at 1,600° C.

Even when the metal contained in the object to be treated is an iron alloy such as stainless steel, graphite is eluted by a similar mechanism.

When the mass of the object to be treated (iron) is taken as M₁, the mass of the carbon (graphite) dissolved into the material to be melted is taken as M₂, and the densities are taken as ρ₁ (7.8 g/cm³) and ρ₂ (1.8 g/cm³) respectively, respective volumes V₁ and V₂ of the object to be treated (iron) and the carbon (graphite) dissolved into the object to be treated can be calculated as follows, in the case where the dissolved carbon is 5.5% by mass.

M₁:M₂=94.5:5.5 (equation 1)

M₁=ρ₁V₁ (equation 2)

M₂=ρ₂V₂ (equation 3)

The following equation can be achieved from the equations of (equation 1) to (equation 3).

V₁:V₂=94.5ρ₂:5.5ρ₁ (equation 4)

When actual numerical values of density (ρ₁=7.8 g, ρ₁=1.8) are applied to the equation 4.

V₁:V₂=80:20.

Thus, in the case where the object to be treated is iron, it can be supposed that the graphite crucible 1 can continuously generate air bubbles with eroding the graphite (carbon) in a volume of about 25% (20/80) of the volume of the iron. As a result, it is thought sufficient that the graphite crucible 1 has the thickness of the bottom part which satisfies the relationship of the distance between the gas discharge part periphery Sc and the crucible inner periphery as described above with supposing the erosion of about 25% of the melt in which the material to be melted and the graphite are melted.

In the case where the object to be treated is an iron alloy, since the content of iron is smaller than pure iron, the amount of graphite eluted into the object to be treated is smaller than that in the case of pure iron. In the case where the object to be treated contains a ceramic such as concrete or mortar, the molten material (slag) thereof has high viscosity, the reaction with the graphite only occurs partially at the part with which the slag comes into contact and the slag is less likely to react wholly. Therefore, the influence of the erosion of the graphite crucible by the slag is smaller, so that it is thought sufficient to consider the influence of the metal object to be treated mainly.

As for the size of the graphite crucible 1, for example, the outer diameter Ro is 975 mm. the inner diameter Ri is 795 mm, the height h is 900 mm, and the depth d0 is 795 mm. Oil the body part, 20 pieces of the gas discharge part are provided rotationally symmetrically with the central axis of the graphite crucible being centered. PCD (Pitch Circle Diameter) of the gas discharge part is 920 mm and each gas discharge part has an opened port 5a and a closed port 5b each having a diameter o of 20 mm and has a depth d1 of 870 mm. Incidentally, in the case where t is taken as a constant minimum value, the minimum value of t is obtained to be 52.5 mm when calculated as PCD=φ+2t+Ri, and t=(PCD−φ−Ri)/2.

Next, there will be described a graphite crucible according to an embodiment 2 of the invention.

FIG. 2(A) is a sectional view including a central axis of the graphite crucible of the embodiment 2 according to the invention, and FIG. 2(B) is a top plan view of the graphite crucible according to the embodiment 2 of the invention.

The graphite crucible 1 according to the embodiment 2 of the invention is configured such that the gas discharge part 5 is provided continuously in a groove shape around the body part in the graphite crucible 1 of the embodiment 1, in which the minimum value of the distance t between the gas discharge part periphery 5c and the crucible inner periphery 1a is the same as in the embodiment 1 except that the gas discharge part 5 has a circular ring shape with a constant thickness, and the embodiment 2 has the similar function to the embodiment 1.

In the present embodiment 2, since the gas discharge part is formed in a groove shape, the gas generated from the inside of the graphite crucible can be made easier to be caught as compared with the embodiment 1. Therefore, it is possible to make the corrosive gas further less likely to reach the melting apparatus around the crucible. The depth d1 of the groove of the gas discharge part is not particularly limited but it is preferable to have such a depth that the closed port 5a reaches the bottom part of the graphite crucible. When the gas discharge part has such a depth that it reaches the bottom part of the graphite crucible, a larger amount of the gas generated from the inside of the graphite crucible can be caught.

Also in the embodiment 2 of the invention, it is thought that bumping can be less likely to occur since the graphite crucible 1 can generate air bubbles in the case where an iron-based, a silicon-based, a nickel-based, or a titanium-based object to be treated, or an object to be treated composed of a mixture thereof is melted, similarly to the embodiment 1.

As for the size of the graphite crucible 2, for example, the outer diameter Ro is 975 min, the inner diameter Ri is 795 mm, the height h is 900 mm, and the depth d0 is 795 mm. In the body part, a gas discharge part having an inner diameter Riφ of 900 mm, an outer diameter Roφ of 940 mm, and a depth d1 of 500 mm is formed in a groove shape which surrounds the body part. The minimum value of t is constant and is 52.5 mm.

Since the graphite crucibles of the embodiments 1 and 2 of the invention are made of graphite excellent in thermal resistance, thermal shock resistance, and the like, they can be used in any heating apparatus. They can be utilized in any inciting apparatus for induction heating, plasma heating, radiation heating by a heater, or the like. In the case where the object to be treated contains a large amount of ferromagnet such as iron or nickel, heating efficiency is high in the object to be treated as compared with the crucible that has weaker magnetism, so that the treatment can be efficiently performed using a melting apparatus for induction heating. In the case of a melting apparatus for plasma heating, graphite is strong in thermal shock owing to a small thermal expansion coefficient (4 to 5 ppm/K) and a large thermal conductivity (80 to 120 W/mK), so that the graphite crucible is stable even when temperature is steeply elevated or the crucible is exposed to high temperature. Moreover, M the case of a melting apparatus for radiation heating, since the graphite crucible has a high radiation rate and also a high thermal conductivity, the object to be treated can be efficiently heated. By treating the object to be treated by the above apparatus using the crucible of the invention, a volume-reduced solidified body can be obtained.

As the object to be treated which is to be subjected to the treatment in the graphite crucibles of the embodiments 1 and 2 of the invention, one containing iron as a main component is suitable but any substances other than iron may be included. For example, the object to be treated ma contain a metal other than iron, slag, concrete, an organic polymer, a salt, a halogen compound, and the like.

### EXAMPLES

Next, Examples of the invention will be described, but it should be appreciated that the invention is not limited to these.

### Example 1

A graphite crucible of the embodiment 1 shown in FIG. 1 was used. Specifically, a graphite crucible having an outer diameter Ro of 40 mm, an inner diameter Ri of 30 mm, a height h of 40 mm, and a depth d0 of 30 mm was used.

On the body part of the graphite crucible, 8 pieces of the gas discharge part were provided rotationally symmetrically with the central axis of the graphite crucible being centered. PCD (Pitch Circle Diameter) of the gas discharge part is 36 mm and each gas discharge part has a diameter φ of 2 mm and a depth d1 of 35 mm. The minimum value of t is 2 mm.

The inner volume (volume of treatment part) of the graphite crucible of the present Example is 21.2 ml and the volume occupied by the graphite crucible (volume of graphite) is 25.6 ml. The graphite crucible was prepared by cutting a fine carbon material (isotropic graphite): ET-10 manufactured by IBIDEN Co., Ltd. The bulk density of ET-10 that was used for the crucible was 1,750 kg/m³.

Iron fragments of 50 g were placed in the graphite crucible of the invention as an object to be treated, and heated in a heating furnace in an argon atmosphere. On this occasion, the object to be treated was filled into the graphite crucible to the upper end thereof.

The heating furnace containing the graphite crucible of the present Example was heated at a temperature elevation rate of 500° C./H, and then kept at 1,600° C. for 6 hours. Then, it was naturally cooled.

The graphite crucible of the present Example taken out from the furnace after cooling was not changed in appearance as compared with that before heating, and no mark of iron which might be melted and scattered around the graphite crucible was observed. The object to be treated placed in the graphite crucible of the present Example was incited and the volume was reduced. The graphite crucible of the present Example taken out after cooling was divided into two pieces so as to include, the central axis and the cross-section was observed. While the thickness of the bottom part of the graphite crucible was originally 10 mm, it was greatly eroded such that the thickness was diminished to 7 mm, but the erosion did not reach the outer surface.

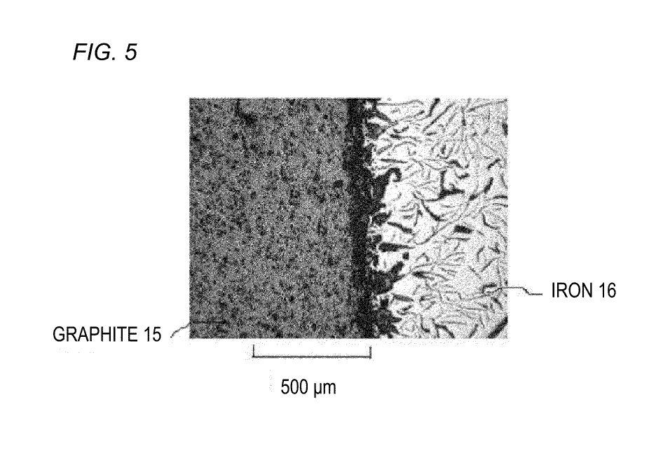

FIG. 5 shows a polarization-microscopic photograph of a boundary region between the graphite crucible and the object to be treated (iron) at a divided cross-section after heating according to the present Example. The polarization microscope was manufactured by Nikon Corporation and n extended image of 25 magnifications was photographed by a collimate method.

It is thought that the left hand in FIG. 5 is graphite constituting the crucible and the right hand in FIG. 5 is cast iron in which the graphite constituting the crucible is dissolved into iron. A striated texture was observed in the cast iron at the right hand in FIG. 5 and thus it is realized that once melted graphite is precipitated again through temperature falling. It is presumed that the object to be treated becomes gray cast iron with an increase in carbon content.

### Example 2

A graphite crucible of the embodiment 2 shown in FIG. 2 was used.

Specifically, a graphite crucible having an outer diameter Ro of 40 mm, inner diameter Ri of 30 mm, a height h of 40 mm, and a depth d0 of 30 mm was used.

In the body part of the graphite crucible, a gas discharge part having an inner diameter Riφ of 34 mm, an outer diameter Roφ of 38 mm, and a depth d1 of 20 mm is formed in a groove shape which surrounds the body part. The minimum value of t is 2 mm.

The inner volume (volume of treatment part) of the graphite crucible of the present Example is 21.2 ml and the volume occupied by the graphite crucible (volume of graphite) is 24.6 ml. The graphite crucible was prepared b cutting a fine Carbon material (isotropic graphite): ET-10 manufactured by IBIDEN Co., Ltd. The bulk density of ET-10 that was used for the crucible was 1,750 kg/m³.

The object to be treated same as in Example 1 was placed in the graphite crucible of the invention and was then subjected to a heating treatment in the same manner.

The graphite crucible of the present Example taken out from the furnace after cooling was not changed in appearance as compared with that before heating, and no mark of iron which might be melted and scattered around the graphite crucible was observed. The object to be treated placed in the graphite crucible of the present Example was melted and the volume was reduced. The graphite crucible of the present Example taken out after cooling was divided into two pieces so as to include the central axis and the cross-section was observed. While the thickness of the bottom part of the graphite crucible was originally 10 mm, it was greatly eroded until the thickness was diminished to 7 mm, but the erosion did not reach the outer surface.

### Comparative Example 1

In Example 1 or 2, a crucible without providing a gas discharge part was used. The material constituting the crucible was not graphite but the crucible was made of magnesia containing magnesium oxide as a main component. The outer diameter Ro is 40 mm, the inner diameter Ri is 30 mm, the height h is 40 min, the depth d0 is 30 min, the inner volume (volume of treatment part) of the crucible is 21.2 ml, and the volume occupied by the crucible (volume of magnesia) is 29.1 ml.

The object to be treated same as in Example 1 was placed in the crucible of the Comparative Example, and was subjected to a heating treatment in the same manner.

The crucible of Comparative Example 1 taken out from the furnace after cooling was not changed in appearance as compared with that before heating. It seemed that bumping had occurred, and a part of the object to be treated was scattered outside the crucible. The crucible of Comparative Example 1 taken out after cooling was divided into two pieces so as to include the central axis and the cross-section was observed. The inner surface of the crucible was not eroded.

From the above results, in the graphite crucibles of Examples 1 and 2, it can be confirmed that, even when graphite as a material of the graphite crucibles is incited into iron as an object to be treated, a sufficient thickness remains, no hole is generated and no crack is generated, and the bumping of the object to be treated becomes less likely to occur since air bubbles are generated at the time when the graphite is melted.

On the other hand, in the crucible of Comparative Example, since the material is made of magnesia that is difficult to melt into the object to be treated. the crucible is hardly consumed by the object to be treated but it is thought that bumping is likely to occur since air bubbles are difficult to generate.

While the invention has been described in detail and with reference to specific embodiments thereof, it will be apparent to one skilled in the art that various changes and modifications can be made therein without departing from the spirit and scope thereof. The present application is based on Japanese Patent Application No. 2011-171793 filed on Aug. 5, 2011, and the contents are incorporated herein by reference.

### INDUSTRIAL APPLICABILITY

The use of the present invention is not particularly limited so long as it is a graphite crucible for melting an iron-based, a silicon-based, a nickel-based, or a titanium-based object to be treated, or an object to be treated composed of a mixture thereof, and can be utilized for crucibles for producing castings, crucibles for reducing the volume of wastes, and the like.

### DESCRIPTION OF REFERENCE NUMERALS

1: graphite crucible, 1a: crucible inner periphery, 1b: crucible outer periphery, 2: bottom part, 2a: inner bottom surface, 2b: outer bottom surface, 3: body part, 4: treatment part, 4a: input port, 5: gas discharge part, 5a: closed port, 5b: opened port, 5c: gas discharge put t: distance between gas discharge part periphery and crucible inner periphery, 6,7: melting point of silicon, 11: melting point of Fe, 12: eutectic point, 13: liquidus line, graphite crucible (Ro: outer diameter, Ri: inner diameter, h: height, d0: depth, T: thickness of bottom part), gas discharge part (φ: diameter, Roφ: outer diameter, Riφ inner diameter, d1: depth), 15: graphite, 16: iron.

1. A graphite crucible comprising:
a bottom part;
a body part;
a treatment part including an input port; and
a gas discharge part that is closed at a lower end side and is opened at an upper end side of the body part.

2. The graphite crucible according to claim 1,
wherein the gas discharge part is formed in a groove shape.

3. The graphite crucible according to claim 1,
wherein a thickness of the bottom part is thicker than a minimum value of a distance between a periphery of the gas discharge part and an inner periphery of the crucible.

4. The graphite crucible according to claim 1,
wherein the graphite crucible has a bulk density ranging from 1,700 to 1,850 kg/m³.

5. The graphite crucible according to claim 1,
wherein the graphite crucible has an impurity content of 1.0% by mass or less.

6. The graphite crucible according to claim 5,
wherein the graphite crucible has an impurity content of 0.1% by mass or less.

7. The graphite crucible according to claim 6,
wherein the graphite crucible is used for melting an object to be treated selected from an iron-based object, a silicone-based object, a nickel-based object, or a titanium-based object, and a mixture thereof

8. A method for producing a solidified body of an object to be treated using the graphite crucible according to claim 1.
